(19) United States
(12) Patent Application Publication
(10) Pub. No.: US 2008/0213554 A1
(43) Pub. Date: Sep. 4, 2008

(54) Protective Glove for Technical Work

(76) Inventors: Andrei Borisovich Vinokurov, Novosibirsk (RU); Sergei Nikolaevich Slepukhin, Moscow (RU); Pavel Vsevolodovich Shilovskiy, Moscow (RU)

Correspondence Address: SoCAL IP LAW GROUP LLP, 310 N. WESTLAKE BLVD. STE 120, WESTLAKE VILLAGE, CA, 91362, US

(21) Appl. No.: 11/762,696

(22) Filed: Jun. 13, 2007

(30) Foreign Application Priority Data
Mar. 2, 2007 (RU) 2007107845

(51) Int. Cl. B32B 7/02

(52) U.S. Cl. 428/215; 428/220

(57) ABSTRACT

The invention relates to means of individual protection for the skin of the hands from the outside aggressive environments, namely, while conducting technical work: remodeling and construction work such as painting; agricultural work, such as gardening or harvesting; servicing a car, etc. The protective glove for conducting technical work is fabricated from an elastic close-cell polymer material, its pores are filled with gas, whereas said material has a thickness of 0.1 mm-5 mm, with average pore diameter between 0.03 micron and 30 microns, with the volume of cavities, filled with gas, no less than 45%, with the share of pores no less than 55%.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field of Invention

The invention relates to the means of individual protection for the hands from aggressive environments, namely, while doing household and technical work; remodeling and construction work such as painting; agricultural work, such as gardening or harvesting; servicing a car, etc.

2. Level of Technology

A latex-covered textile protective glove, TY6-55-221—is known. Its drawbacks are labor-intensive and material-intensive manufacturing. Use of previously up-vulcanized latex mixes requires many ingredients in the mix (up to 6-7), which lowers mechanical integrity of the coating, while brittleness increases. The coating mix preparation process becomes complicated.

The closest analogue to the glove in this application is a protective glove of a three-dimensional configuration made from thermoplastic flat material RU 43748 U1.

A disadvantage of this glove is its low strength and low functionality due to moisture penetration.

### SUMMARY OF THE DISCLOSURE

This document describes disposable gloves for household and technical work. The gloves may be fabricated from non-woven cellular polyethylene laminated with low density polyethylene by heat sealing with a heated instrument.

The gloves are fabricated with a side seam for the right hand, their design follows the shape of a hand.

The gloves are fabricated in two sizes—“S” and “M”. Glove configuration and linear sizes correspond to the following drawings and table.

The gloves may be fabricated in various colors by applying the color layer or without it. A printed color layer may be positioned between the NPE and PLD layers.

The one-time use gloves for household and technical work fabricated from non-woven polyethylene foam laminated with low density polyethylene are designed for protecting the skin of the hands from soiling factors while performing light work.

The gloves may be fabricated in the following sizes:

Glove dimensions, mm

| Measurement designation | S | M |
|---|---|---|
| Length, L, mm | 265 ± 15 | 275 ± 15 |
| Palm width, a, mm | 147 ± 7 | 157 ± 7 |
| Wrist width, b, mm | 115 ± 10 | 130 ± 10 |

### DESCRIPTION OF THE DRAWINGS

FIG. 1 is a plan view of a small-size glove.

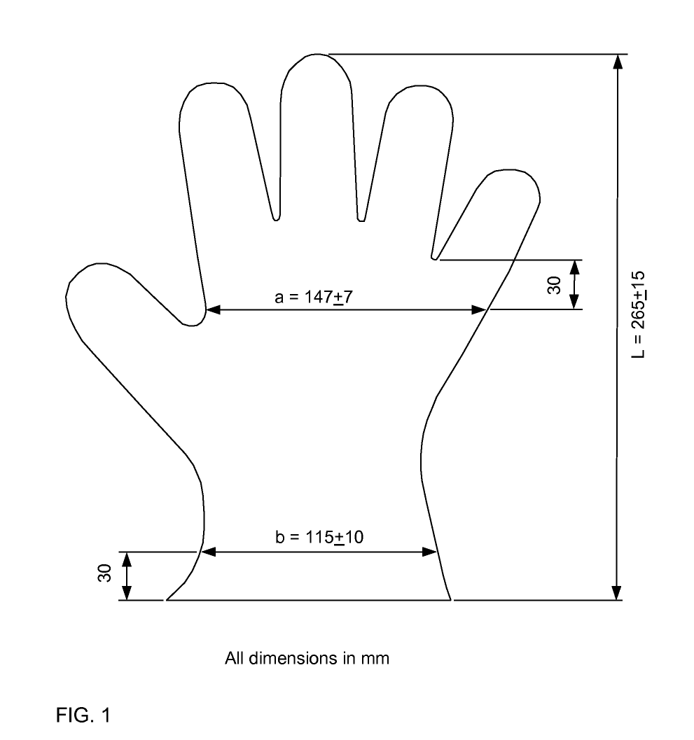

FIG. 2 is a plan view of a medium-size glove.

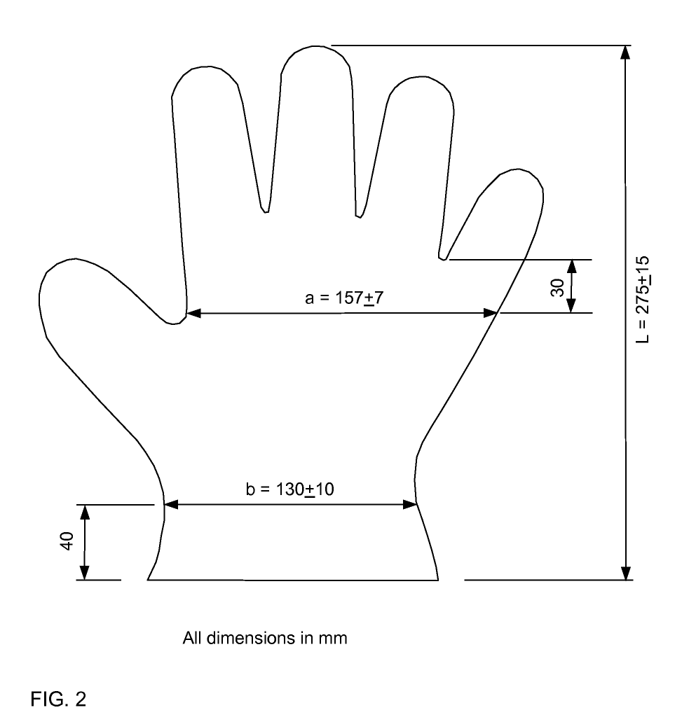

### DETAILED DESCRIPTION

Description of Apparatus

The purpose of the current invention is creation of a versatile and practical protective glove for technical and household work.

This purpose is achieved by manufacturing the glove from an elastic close-celled polymer material, its pores filled with gas. This material is 0.1 mm-5 mm thick, with average diameter of pores between 0.03 micron (1 micron=10⁻⁶ meter) to 30 microns, with the volume of cavities filled with gas no less than 45%, with the share of pores no less than 55%.

This glove, apart from flexibility and elasticity, is resistant to aggressive environments, multiple deformations, and has increased strength, water-repelling and thermo-preserving qualities.

The material may be manufactured by any known method, for example, by the method described in the patent WO 89/00918 or U.S. Pat. No. 4,473,665, of extrusion from thermoplastic polymer fibers.

Relative to this invention, the word GLOVE means any item of clothing meant for wearing on a hand, i.e. it may be a glove or a mitt, etc. Therefore, the glove may be manufactured as a work glove.

In addition, the glove may be laminated with polyethylene film 10 microns to 40 microns thick.

The lamination of the glove may be done by any known method, preferably by gluing or thermal bonding. The polyethylene film of the laminate is fabricated, mainly, from the high- or low-density polyethylene. The laminate may be applied to the external, or to the internal, surface of the glove.

Thermal bonding may be done by any known method, preferably by gluing or by heater calender (mangler).

Information may be put on the glove, either directly onto its surface, or onto an additional layer. This additional layer may be manufactured out of paper or polymer film and be placed between the layers of non-woven material, as well as over the laminate. The information may be of advertising nature.

Exercise (Realization) of the Invention

The loose-fit glove is mold-produced from elastic closed-cell polymer material, its pores filled with gas. This material is 0.1 mm-5 mm thick, with average diameter of pores between 0.03 micron to 30 microns, with the volume of cavities filled with gas no less than 45%, with the share of pores no less than 55%.

An example is a method of manufacturing of material by extrusion from the hot melt, which consists, at least of one amorphous and/or semi crystalline polymer, which is passed under pressure through an extruding press. At the injection stage, foam former is introduced to the hot melt and is squeezed through a forming membrane headpiece. As a result of a drop in pressure during the squeezing through the headpiece, the foaming agent foams the polymer hot melt, forming a structure with closed pores (cells) filled with gas inside the polymer. The pressure in the extruding press must be no less than 120 bars, and temperature, when using amorphous polymers and polymer mixes, must be equal to their glass-transition temperature. At the additional stage of mixing the components, the hot melt temperature is decreased to the one lower than the initial processing temperature, at least, of one polymer and/or the hot melt pressure is raised, thus ensuring the formation of foamed material, characterized by a high volume of cavities no less than 45%. This high volume of cavities is one of the economic factors of the material. At lower temperatures and at higher pressures, a larger quantity of foaming agent may be introduced to the hot melt, without the danger of presence of non-dissolved gas bubbles in the hot melt, which may lead to undesirable effects. This higher quantity of the foaming agent ensures the formation of a larger number of gas bubbles during the process of pore formation.

The lowering of the hot melt temperature and/or raising its pressure at the additional mixing stage allows, at the corresponding injection stage, to force into the polymer hot melt an excessive amount of foaming agent, compared to the amount that can dissolve in the hot melt at the prevailing temperature and pressure of the hot melt. Access foaming agent is completely transferred to the solution at the additional stage of mixing. This creates a possibility to manage the process by adjusting the amount of foaming agent in the hot melt, thus, by the volume of cavities and by the density of pores in the membrane. On the whole, the temperature of the polymer hot melt is defined by the minimally-required viscosity, at which the economical function of the extruder and the normal functioning of technical devices is still possible. However, at the additional stage of mixing, the softening effect of the foaming agent, dissolved in the hot melt, is used. Because with the increase in the amount of foaming agent the initial temperature of the softening of polymer decreases, at the additional stage of mixing after adding the foaming agent, such as CO₂, the working temperature may be lowered compared to the initial working temperature to the value of up to 100 degrees C. and without the increase in the viscosity of the hot melt. To achieve the pronounced desired effects the temperature must be lowered no less than by 50 degrees C.

It has been determined that if substances consisting of at least two gases under normal conditions are used as foaming agents introduced to the polymer melt, the resulting foamed polymer materials have a high share of closed pores. The foaming agents should be, at least, practically fully inert relative to the polymers used in the extrusion mass. Preferably carbon dioxide and water are used.

While using the gas mixture consisting of at least two gases with various rates of diffusion, the gas with the lower rate of diffusion creates a lower internal pressure within the cell, which leads to the closed cells not rupturing. It is preferable to introduce liquefied foaming agents to the extrusion mass. For a precise dosage batching of the foaming agent, the liquefied foaming agent is forced into a moving stream of the polymer hot melt with the help of, for example, dosage batching pumps equipped with cooling heads for a precise dosage batching of liquid. So, for example, while using carbon dioxide as one of at least two foaming agent, by using a high speed flow blow-off valve, installed after the pump, with the help of this pump CO₂, fed from a compressed gas tank, may be compressed further to 75 bars, liquefied, batched up in the liquid form and injected into the polymer hot melt during the extrusion. During this, the pump head temperature must be maintained at lower than 14 degrees C., preferably −10 degrees C., in order for the density of CO₂ to be consistent, which in turn is a necessary condition for the batched up amount of the liquefied CO₂ to be maintained at constant level. The material may contain amorphous and semicrystallized thermoplastic polymers and their mixtures, selected from the group that contains cellulose derivatives and polyolefins, complex polyethers, polysulfones, polyethersulfones, poliamides and their substitute products, such as polyvinyliden fluoride. Particularly preferred is the group that includes complex polyethers, polysulfones and polyethersulfones. The material with an average pore diameter between 0.05 micron to 20 microns is preferred. This material is characterized by the volume of cavities no less than 45%, with the share of open pores no less than 55% and pores distribution of size with standard deviation +/−10% from the mean pore diameter.

The material may be laminated on one side or on both sides. Film, cloth, knitted fabrics or non-woven polymer materials may be used as laminate. Preferably, low pressure or high-pressure polyethylene is used as laminate.

The three-dimensional glove (mitt) of various sizes is manufactured from the laminated polymer material. The layer contacting skin, as a rule, is the non-woven polymer material with micro pores.

As an option the glove may carry information applied to the additional layer—paper, cloth, film, etc. This information may be of technical nature, as well as of advertising nature, for example, about the manufacturer. Between the material and the laminate, the glove may have an additional paper layer carrying technical information about the work sequence or work safety requirements.

The additional layer may be applied directly on the glove and be placed, for example, between the non-woven material and the laminate, as well as over the laminate.

### EXAMPLES OF SPECIFIC IMPLEMENTATION

### Example 1

The loose-fit glove is mold-produced from elastic closed-cell polymer material, its pores filled with gas. This material is 0.1 mm-5 mm thick, with average diameter of pores between 0.03 micron to 30 microns, with the volume of cavities filled with gas no less than 45%, with the share of pores no less than 55%.

Such glove is very convenient to use, because it is made from thin sturdy material, allows user to perform work outside at cold temperatures.

### Example 2

The glove manufactured according to the Example 1 has an additional layer of laminate, made from low density polyethylene, on the outer surface of the glove.

### Example 3

The glove manufactured according to the Example 2 contains information between the layers on the surface of the main material of the glove.

### Application Example

While conducting work inside a coal-mine, a miner wears gloves. The miner's hands remain dry and clean and provide electric isolation. Thanks to the work order and safety information applied to the outer surface of the glove, the worker obeys the safety rules while working with power tools and is less distracted, thus increasing the work productivity.

The protective glove has a high tensile rupture strength, is soft, preserves warmth (reflects the body heat of the user), is pleasant to a touch, does not cause skin irritation, absorbs sweat from the hands, its use increases job safety because of the safety information that may be applied to it, increases comfort while performing work.

1. A protective glove for conducting technical work, comprising
an elastic closed-cell polymer material having pores filled with gas, wherein
the material has a thickness of 0.1 mm-5 mm,
the pores have an average diameter between 0.03 micron and 30 microns,
the volume of pores filled with gas no less than 45%, and
the total volume of pores no less than 55%.

2. The protective glove according to claim 1, wherein said glove is fabricated in the shape of a glove.

3. The protective glove according to claim 2, wherein said glove is laminated with polyethylene film 10 microns-40 microns in thickness.

4. The protective glove according to claims 1 or 2, wherein the said polymer contains polyethylene foam and/or propylene foam.

5. The protective glove according to claim 3, wherein the lamination is performed by gluing.

6. The protective glove according to claim 3, wherein the lamination is performed by thermal pressing.

7. The protective glove according to claim 3, wherein the said polyethylene film of the laminate is fabricated from low density polyethylene.

8. The protective glove according to claim 3, wherein the said polyethylene film of the laminate is fabricated from high density polyethylene.

9. The protective glove according to claim 1, wherein the said laminate layer is applied on two sides of the said glove—the inside and the outside.

10. The protective glove according to claim 2, wherein said glove contains said laminate layer on the inside.

11. The protective glove according to claim 2, wherein said glove contains said laminate layer on the outside.

12. The protective glove according to claim 2, wherein said glove carries information.

13. The protective glove according to claim 3, wherein said glove has an additional layer, whereupon said layer information is applied.

14. The protective glove according to claim 10, wherein said additional layer is fabricated from paper or cloth, or polymer film.

15. The protective glove according to claim 10, wherein said additional layer is placed between layers of non-woven material and laminate, or above the laminate.

16. The protective glove according to claim 10, wherein said information may be of advertising nature.
